(19) United States
(12) Patent Application Publication
(10) Pub. No.: US 2005/0180164 A1
(43) Pub. Date: Aug. 18, 2005

(54) Display

(76) Inventor: Pang-Lun Yang, TaiChung (TW)

Correspondence Address: BIRCH STEWART KOLASCH & BIRCH, PO BOX 747, FALLS CHURCH, VA, 22040-0747, US

(21) Appl. No.: 10/727,498

(22) Filed: Dec. 5, 2003

(30) Foreign Application Priority Data
May 13, 2003 (TW) 92112870

(51) Int. Cl. F21V 7/04

(52) U.S. Cl. 362/600

(57) ABSTRACT

The invention is to provide a display having a display screen, a light source, an accommodating device, a light guide plate, and a reflection film. The display screen has an outer frame. The light source is positioned at one side of the display screen. The accommodating device is adapted to accommodate the light source. The accommodating device has at least one side surface, and an opening is formed on the side surface. The light guide plate is position next to the side surface of the accommodating device. The reflection film is pasted on the light guide and the light guide plate is positioned between the accommodating device and the reflection film. Lights of the light source are directed into the light guide plate via the opening of the accommodating device first and reflected by the reflection film, so that the outer frame of the display screen is self-illuminated.

### FIELD OF THE INVENTION

The invention relates to a display, more particularly, to a display having a self-illuminated outer frame.

### BACKGROUND OF THE INVENTION

Following the rapid development of modern technology, the electronics-related techniques also progress each day. In addition, the computer display has become an electronic product browsed by modern people all the time.

Because display has such a close relationship with our everyday life, how to optimize a computer display has become an urgent necessity for each electronic manufacture. One way to enhance the competitiveness of the industry and increase the market share is to provide a display having more functions or visual effects without increasing the manufacture cost.

### SUMMARY OF THE INVENTION

The main objective of the present invention is to provide a display having a self-illuminated outer frame without an additional light source so that the display is comfortable for watching.

To fulfill above-mentioned objective, the present invention is to provide a display, and the display includes a display screen, a light source, an accommodating device, a light guide plate, and a reflection film.

The display screen has an outer frame. The light source is arranged at one side of the display screen. The accommodating device is adapted to accommodate the light source, the accommodating device has at least one side surface the accommodating device having at least one side face, and an opening is formed on the side surface. The light guide plate is positioned next to the side surface of the accommodating device. The reflection film is pasted on the light guide plate, and the light guide plate is positioned between the accommodating device and the reflection film. the light guide plate is substantially positioned around the outer frame of the display screen, lights of the light source are directed into the light guide plate via the opening first and reflected by the reflection film, so that the outer frame of the display screen is self-illuminated.

### BRIEF DESCRIPTION OF THE DRAWINGS

FIG. 1 is a diagram showing the structure of a preferred embodiment according to the present invention.

FIG. 2 is an illustration showing the front view of the preferred embodiment of FIG. 1.

FIG. 3 is a cross-sectional view alone A-A line in FIG. 2.

### DETAILED DESCRIPTION OF THE INVENTION

The main characteristic of the present invention is to accommodate a light source in an accommodating device positioned at one side of a display screen. An opening is arranged at one side surface of the accommodating device for guiding lights of the light source into a light guide plate, by which the light is uniformly distributed, such that the display has a self-illuminated outer frame.

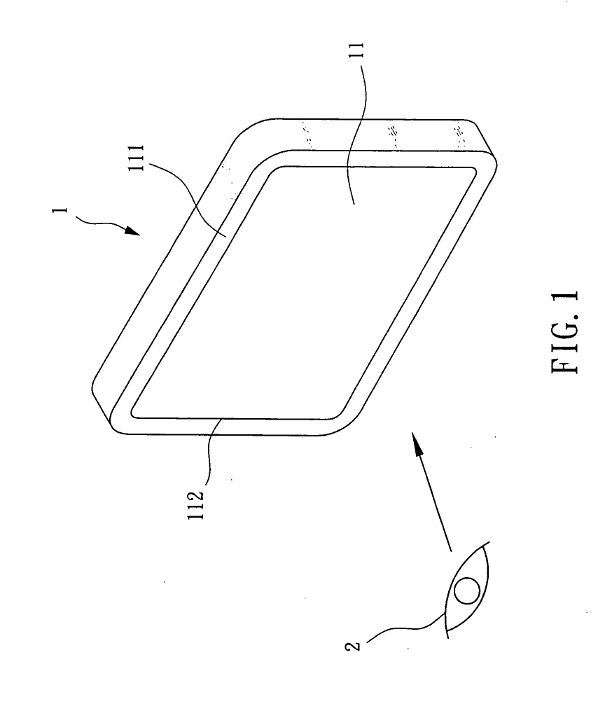

Please refer to FIG. 1, which is a diagram showing the structure of a preferred embodiment according to the present invention. The display 1 has a display screen 11 to provide an observing function to an operator 2. In this embodiment, the display screen 11 is in a rectangular structure and has two long sides 111 and two short sides 112. The shape of the display screen 11 is not limited. The shape of the display screen 11 can be changed by a person skilled in the art.

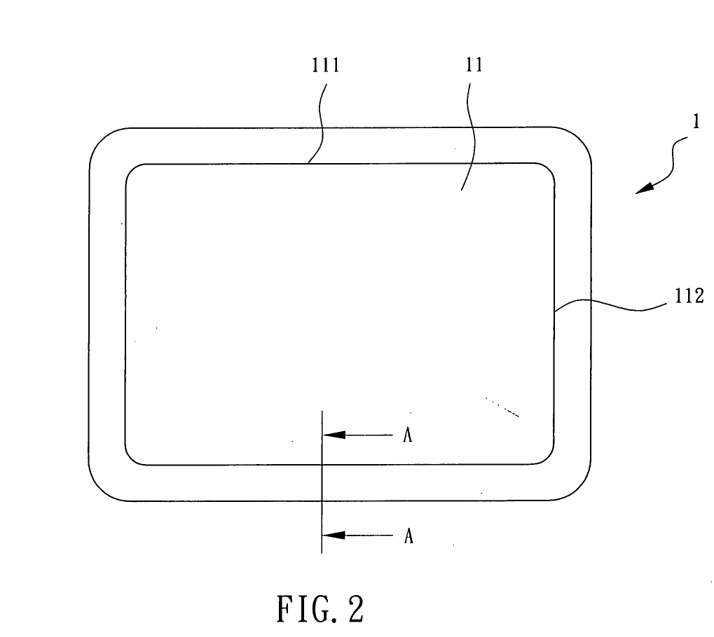

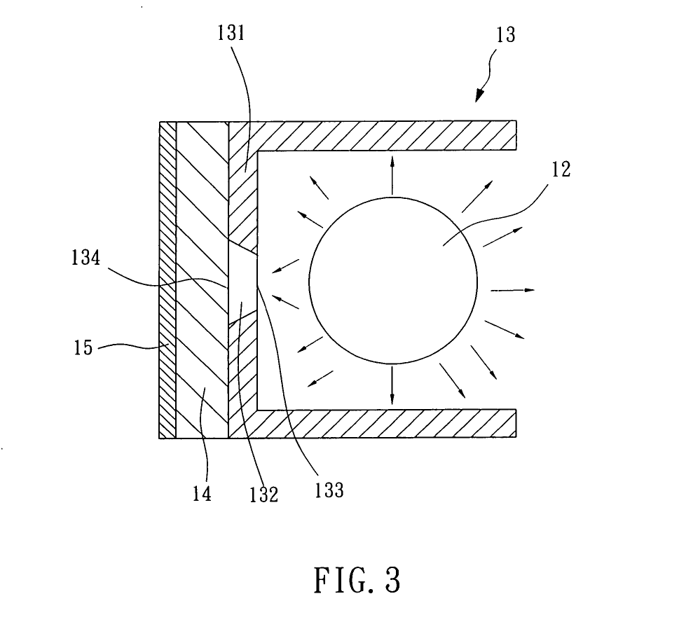

Please refer to FIG. 2 and FIG. 3, which are the structural illustrations showing a front view and a cross-sectional view of line A-A in the preferred embodiment. The display 1 according to the present invention has a display screen 11, at least one light source 12, an accommodating device 13, a light guide plate 14, and a reflection film 15. The light source 12 can be positioned at one of the long sides 111, or at one of the short sides 112. Moreover, the display can includes two light sources positioned at two lone sides or two short sides. The number and the position of the accommodating device are varied according to the light source. The number of the light sources, the position of each light source, and the number and position of the accommodating device are not limited and can be adjusted by any person skilled in the art.

For clarity, one cross sectional view of line A-A is used to describe the present invention. Please refer to FIG. 3. The accommodating device 13 is made of non-light-transmitting materials. The accommodating device 13 can be formed in one piece by an injection molding process or a metal stamping process. The accommodating device 13 has a side surface 131, and an opening 132 is formed on the side surface. The light guide plate 14 is positioned next to the side surface 131 of the accommodating device 13. The light guide plate 14 is positioned around the two long sides 111 and the twp short sides of the display screen 11. The light guide plate 14 is made of light-guiding materials, such as acrylic material, for allowing lights of the light source 12 to pass through. The light guide plate can be manufactured by an injection molding process. The opening 132 has an upper section 133 and a lower section 134, the upper section 133 is faced to the light source 12, and the lower section 134 is faced to the light guide plate 14. Lights of the light source 12 may be guided and uniformly distributed to the light guide plate 14 through the opening 133. Furthermore, the second area of the lower section 134 is not smaller than the first area of the upper section 133. Therefore, lights of the light source 12 can be diverged to the light guide plate 14. In addition, lights can be reflected by the reflection film 15 to increase the brightness of the light source 12. The light guide plate can be positioned around the outer frame of the display screen 11, so lights of the light sources can be guided to surround the display screen 11. Finally, the outer frame of the display screen 11 is self-illuminated.

In summarizing the above-mentioned description, the display of the present invention may indeed have a self-illuminated outer frame that has beautiful appearance and function of convenient observation, so the present invention may really overcome the shortcomings of prior arts to satisfy the needs of industry and raise their competition capability.

1. A display, comprising:
a display screen having an outer frame;
a light source arranged at one side of the display screen;
an accommodating device for accommodating the light source, the accommodating device having at least one side face, and an opening being formed on the side surface;
a light guide plate positioned next to the side surface of the accommodating device; and
a reflection film pasted on the light guide plate, the light guide plate being positioned between the accommodating device and the reflection film;
wherein the light guide plate is substantially positioned around the outer frame of the display screen, lights of the light source are directed into the light guide plate via the opening first and reflected by the reflection film, so that the outer frame of the display screen is self-illuminated.

2. The display according to claim 1, wherein the accommodating device is made of non-light-transmitting materials.

3. The display according to claim 1, wherein the opening has an upper section and a lower section, the upper section is faced to the light source, and the lower section is faced to the light guide plate.

4. The display according to claim 3, wherein a second area of the lower section is not smaller than a first area of the upper section.

5. The display according to claim 1, wherein the display screen has a long side and a short side, and the accommodating device is positioned at the long side of the display screen.

6. The display according to claim 1, wherein the display screen has a long side and a short side, and the accommodating device is positioned at the short side of the display screen.
